(19) United States
(12) Patent Application Publication
(10) Pub. No.: US 2005/0244238 A1
(43) Pub. Date: Nov. 3, 2005

(54) Hole resizing arbor for power drills

(76) Inventor: Donald E. Burk, San Antonio, TX (US)

Correspondence Address: Donald E. Burk, 510 Wilmington #2, San Antonio, TX, 78212, US

(21) Appl. No.: 10/833,956

(22) Filed: Apr. 29, 2004

(51) Int. Cl. B23B 51/04

(52) U.S. Cl. 408/204

(57) ABSTRACT

An assembled hole resizing arbor 10, using an existing pilot hole 101 in a work piece 100 to produce an enlarged finished hole 102 in the work piece 100 centered around the pilot hole 101 wherein the assembled arbor 10 includes a larger diameter finish hole saw 30 mounted in a concentric relationship the pilot hole saw 40 wherein both of the hole saws 30 and 40 are mounted on a shaft member 21 connected to a power drill 200 such that the pilot hole saw 40 engages the sides of a pilot hole 101 in a work piece 100 to act as a guide element for the larger diameter finish hole saw 30 to create the desired enlarged finished hole 102 in the work piece.

### CROSS REFERENCE TO RELATED APPLICATIONS

Not applicable.

### BACKGROUND OF THE INVENTION

1. Field of the Invention

The present invention relates to the field of hole enlarging methods and apparatus and in particular to a pilot hole drilling and guiding arrangement for resizing existing holes to a larger diameter using an existing hole as a pilot guide.

2. Description of Related Art

As can be seen by reference to the following U.S. Pat. Nos. 5,871,310; 2,874,616; 5,143,489; 5,366,326, the prior art is replete with myriad and diverse hole drilling arrangements.

While all of the aforementioned prior art constructions are more than adequate for the basic purpose and function for which they have been specifically designed, they are uniformly deficient with respect to their failure to provide a simple, efficient, and practical device that employs an existing pilot hole to guide a larger hole saw into the workpiece in a continuous operation.

As most craftsmen are all to aware, an inordinate amount of time is expended while enlarging an existing hole in a workpiece which must then be subjected to a cutting process with or without the use of a separate guide element to enlarge the radius of an existing pilot hole to arrive at an enlarged finished hole diameter.

As a consequence of the foregoing situation, there has existed a longstanding need among craftsmen for a new and improved hole cutting drill bit arrangement wherein the pilot hole guide is axially aligned with and protrudes outwardly from the finish hole saw so that the pilot hole guides the finish hole saw in a single continuous sequence; and the provision of such an arrangement is the stated objective of the present invention.

### BRIEF SUMMARY OF THE INVENTION

Briefly stated, the hole resizing arbor that forms the basis of the present invention comprises in general a shaft unit comprised of three distinct portions: an upper cylindrical portion, an intermediate cylindrical portion, and an elongated threaded lower portion; therein, which will accept a pilot hole guiding unit, and a finish hole saw deployed in a concentric staggered fashion on the shaft unit.

As will be described in greater detail further on in the specification, the pilot hole guiding unit fits inside and projects beyond the cutting end of the finish hole saw such that after the shaft unit has been operatively connected to a conventional power drill, the power drill can be operated to enlarge the diameter of an existing pilot hole.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of the hole resizing tool that forms the basis of this invention in use on a workpiece;

FIG. 2. Is a cross-sectional view taken through line 2-2 of FIG. 1; and,

FIG. 3 is an exploded perspective view of the arbor, pilot hole guide and finish hole cutting units depicted in phantom.

### DETAILED DESCRIPTION OF THE INVENTION

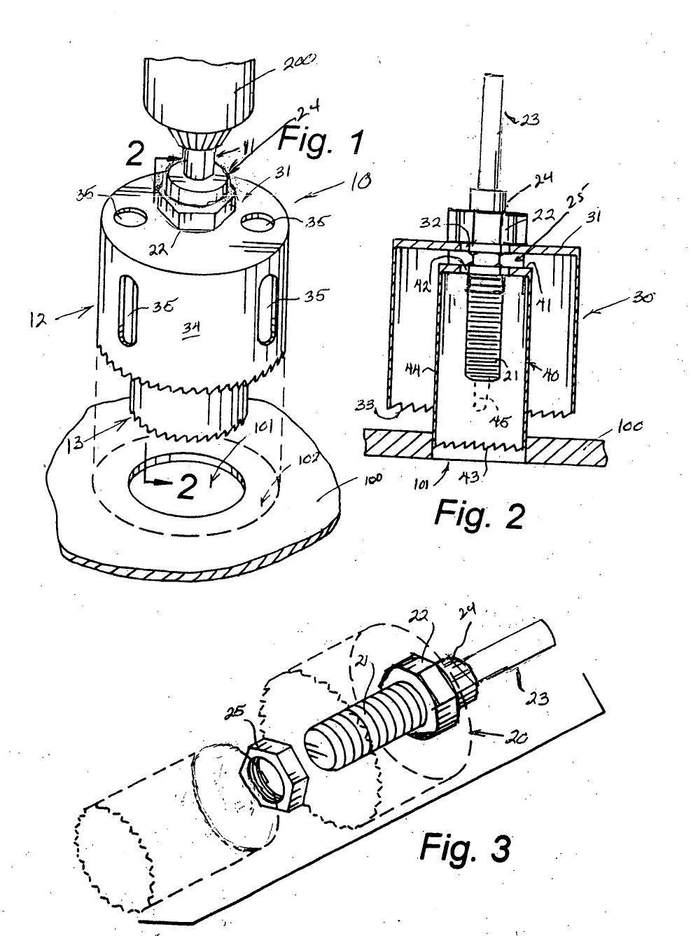

As can be seen by reference to the drawings, and in particular to FIG. 1, the hole resizing bit that forms the basis of the present invention is designated generally by the reference number 10. The resizing bit 10 comprises in general a shaft unit 11, a finish hole cutting unit 12, and a pilot hole guiding unit 13. These units will now be described in seriatim fashion.

As can be seen by reference to FIG. 3, the shaft unit 11 comprises an elongated shaft member 20 having a threaded lower portion 21, an intermediate cylindrical portion 24 and a smooth cylindrical upper portion 23 that forms a gripping surface that is engageable by a conventional power drill chuck 200 as depicted in FIG. 1.

In addition, the shaft unit 11 also utilizes a pair of nuts 22 and 25 whose purpose and function will be described in detail further in the specification.

Turning now to FIGS. 1 and 2 it can be seen that the assembled hole cutting unit 12 comprises an enlarged diameter threaded hole saw unit 30 having a substantially closed upper end 31 comprised of a threaded central aperture 32 whose diameter is less than that of hole saw stop nut 22 which seats against the cylindrical portion 24. The hole saw unit 30 threads onto the threaded shaft portion 21 and seats against the stop nut 22 in a well recognized fashion.

In addition, the lower end of the hole saw 30 is provided with a saw toothed cutting array 33 wherein the outside diameter of the larger hole saw 30 is chosen to conform to the desired diameter of the enlarged hole 102 in the workpiece 100.

As can too be seen by reference to FIG. 1, both the generally closed upper end 31 of the larger hole saw 30 as well as cylindrical side walls 34, are provided with apertures 35 that allow for air circulation within the larger hole saw 30 as well as a means for removing the cut out material produced by the hole resizing process.

Returning once more to FIGS. 1 and 2, it can be seen that the pilot hole saw guiding unit 13 comprises a reduced diameter threaded hole saw 40 having a generally closed upper end 41 provided with a threaded central aperture 42. The spacer nut 25 has two functions. With the larger hole saw 30 and the hole stop nut 22 in position, the spacer nut 25 threads onto the shaft's threaded area 21 and when tightened relieves torsional load on larger hole saw's 30 central threaded aperture 32 and ensures that the pilot hole saw 40 will protrude outward from the finish hole saw 30. The pilot hole saw 40 threads onto the lower threaded area of the unit 21 and rests against spacer nut 25. The pilot hole saw's outside diameter is chosen to match the pilot hole 101 in the workpiece 100.

In addition, the upper end 41 and the side walls 44 of the pilot hole saw 40 may be provided with a plurality of apertures 45 one of which is depicted in phantom in FIG. 2 for the purpose of cooling and shavings elimination as mentioned previously.

Furthermore, as shown in FIGS. 1 and 2 the pilot hole saw 40 is intended to be concentrically aligned with and project beyond the lower end finish hole saw 30, by the function of spacer nut 25.

Once the pilot hole 101 has been formed, the sidewalls of the pilot hole saw 40 cooperate with the sidewalls in the workpiece 100 surrounding the pilot hole 101 to guide the saw toothed lower end 33 of the larger hole saw unit 30 into engagement with the workpiece 100 to create the finished enlarged hole 102 therein.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

1. A hole resizing arbor for use with a hand held power drill will guide a larger hole saw through a work piece with an existing smaller diameter hole;
a shaft unit including a shaft member having an upper portion designed to be engaged in a hand held power drill chuck, a smooth cylindrical intermediate portion, and a lower portion, wherein, the lower shaft member is elongated and threaded; and wherein, the stop nut is threaded onto the threaded lower shaft member and will seat against the smooth, cylindrical intermediate portion, forming a boss for the larger hole saw to seat against,
a pilot hole saw threaded onto the lower portion of the shaft member, whose outside diameter coincides with the pre-existing hole in a work piece; and,
a finish larger hole saw operatively with and disposed in a concentric relationship relative to the smaller pilot hole saw and including a larger hole saw whose diameter is greater than that of the pilot hole saw and having a lower end provided with a saw toothed array whose outside diameter coincides with the desired finished hole in a work piece; wherein, the lower portion of the pilot hole saw is disposed below the saw toothed array of the larger hole saw.

2. The resizing arbor as in claim 1; wherein, the shaft member is elongated and the lower portion of the shaft member is threaded.

3. The resizing arbor as in claim 2; wherein, the shaft unit further comprises the stop nut seated against the smooth cylindrical intermediate portion, forming a boss for the larger finish hole saw to seat against.

4. The resizing arbor as in claim 3; wherein, the larger diameter hole saw has an upper portion provided with a central threaded aperture and will thread directly onto the lower threaded portion of the shaft member and will seat against the boss formed by the stop nut.

5. The resizing arbor as in claim 4; wherein, the spacer nut is threaded onto the lower threaded area of the shaft member and will seat against the larger hole saw and when tightened will relieve torsional stresses placed on the larger hole saw's threaded central aperture during operation.

6. The resizing arbor as in claim 5; wherein, the spacer nut is threaded onto the lower threaded portion of the shaft unit and when tightened will relieve torsional stresses placed on the threaded central aperture of the larger finish hole saw during operation; and, will ensure the smaller pilot hole saw protrudes below the cutting edge of the larger finish hole saw, when the smaller pilot hole saw is threaded onto the lower threaded area and seated against the spacer nut.

7. The resizing arbor as in claim 4; wherein, the larger finish hole saw is threaded onto the lower portion and seats against the boss formed by the stop nut; and, the side wall of the larger finish hole saw is provided with a plurality of apertures.

8. The resizing arbor as in claim 7; wherein, the side wall of the larger hole saw is provided with a plurality of apertures will allow for removal of cutout material.

9. The resizing arbor as in claim 6; wherein, said pilot hole saw will engage the sides of a preexisting pilot hole to serve as a guide element for the larger finish hole saw as it forms a desired finished hole diameter in a work piece.
